(19) United States
(12) Patent Application Publication
(10) Pub. No.: US 2011/0153483 A1
(43) Pub. Date: Jun. 23, 2011

(54) System and Method for Providing Financing for Long/Short Trading Strategies Including Convertible Arbitrage Transactions

(75) Inventors: David Ballard, Darien, CT (US); Robert S. Sloan, New York, NY (US)

(73) Assignee: S3 Direct Funding, LLC.

(21) Appl. No.: 12/717,872

(22) Filed: Mar. 4, 2010

Related U.S. Application Data
(60) Provisional application No. 61/289,973, filed on Dec. 23, 2009.

(51) Int. Cl. G06Q 20/00; G06Q 40/00

(52) U.S. Cl. 705/37

(57) ABSTRACT

A method and apparatus for providing financing for long/short trading strategies including convertible arbitrage transactions is described. First, this novel strategy packages longs and shorts into a single purpose transparent vehicle based on a Single Risk Based Strategy. Second, the platform contains rules-based modules which apply variable margins against securities positions. The Unitary Financial Platform performs daily pricing, risk-based computer modeling, custodial monitoring, client interfacing, and risk reporting to external parties. Third, the funding structure requires that clients contribute capital thereby creating equity in the entity. If multiple parties are involved in a single entity, this requirement puts all clients at risk with respect to the other clients in the context of the rules and provides a clearinghouse like aspect to risk sharing within the entity.

### CROSS REFERENCE TO RELATED APPLICATIONS

This application claims the benefit of U.S. Provisional Patent Application No. 61/289,973, filed Dec. 23, 2009, which is incorporated herein by reference in its entirety.

### BACKGROUND OF THE INVENTION

1. Field of Invention

This invention relates generally to a stand-alone or unitary logical electronic financing platform (with a unique ownership structure) having a communications network connecting investors and banks dealing in financial instruments, and more particularly to a unitary financial platform containing one or more transparent rule based modules for valuing assets, determining margins, and financing risk based (long/short) strategies, with the first one for the convertible arbitrage industry.

2. Background

Prime brokerage is, among other things, the business of financing hedge funds securities positions including equity and equity linked securities. The strategy of lending against securities is a global business with various margin requirements. Because it is an assumption in difficult markets that the client (e.g., a hedge fund) is not a stand alone creditworthy entity, lending is generally based on collateral value only and is generally recourse to all of the client's assets held by a prime broker. Positions in prime brokerage accounts are marked to market daily, and subject to liquidation if specific terms are not met. Thus, margins are adjusted daily and clients typically have only twenty four hours to adjust their positions or their positions are liquidated. In these types of transactions, the prime broker takes physical position of assets as collateral against transactions. This is similar to a margin loan in a retail account transaction.

For prime brokers, convertible arbitrage has been a mainstay product. As background, the goal of convertible arbitrage is to extract a price difference from a market price of a convertible security from a “theoretical” value security. Generally, a market price of convertibles is below the theoretical value of the security. This requires the hedge fund to purchase the convertible security long and short an underlying stock. The arbitrage looks to close the gap over time between these offsetting positions.

For over the last twenty years, the financing of prime brokerage has generally been done in one of two ways. The first alternative has been to borrow from an investment bank parent/broker dealer to fund the margin loan to the hedge fund. Typically, this has occurred with unsecured borrowing at the parent level. In the second alternative, some of the long assets of the hedge fund client have been used as collateral and then re-hypothecated or used in repurchase transactions to finance the investment banks' position, thereby allowing prime brokerage to be self funded within an investment bank. The banks look for a positive funding spread between what they charge hedge fund clients and their cost of financing from these sources. In either scenario, as a requirement to establish a prime brokerage account, hedge fund clients typically must allow the investment bank a right to rehypothecate the assets in order to fund themselves. This practice effectively exposes all hedge fund clients to credit risk of the prime brokerage firm and risks associated with the investment bank's other interests, as those assets are used as security for the investment bank. This is one of the few financial arrangements in which the borrower is subject to the credit risk of the lender.

With the recent fall of major financial service providers, several weaknesses in this long standing business model have become apparent. First, all of the hedge fund's assets are at risk, whether the investment bank uses them or not to finance their position. Second, there is no transparency in the process. Fixed income investors have concerns about funding “black boxes”, i.e. they finance investments banks without a direct linkage to any assets (unsecured lending). Third, if the hedge fund's assets are used to finance the banks, the investment bank only uses the long asset as collateral, not the “packaged” investments as collateral, which generally has significantly lower risk and more stable portfolio value.

A fourth problem with the traditional model is that the current setup creates a “run” potential on the prime broker. If a client of the prime broker perceives excessive risk in the prime broker, the client will be inclined to move assets out of the prime broker, which will in turn reduce the funding capability of the prime broker.

What is needed is a more transparent system and method for investors that operates as a unitary, stand-alone single risk logical entity and not a multipurpose entity like the prime brokers and investment banks. This unitary entity must have access to both the long and short securities positions of individual clients for single risk based strategy financing. In addition, the unitary entity may have one or multiple clients to diversify the positions being financed. Moreover, a system and method is necessary to keep assets segregated, significantly reducing the counterparty risks to all parties in the system. In addition, a system and method is needed that not only finances the long assets, but which also incorporates the short position, resulting in an aggregate hedged financing position as the short position will generally offset a significant amount of market risk in either direction.

### BRIEF DESCRIPTION OF THE DRAWINGS

The accompanying drawings, which are incorporated herein and foam part of the specification, illustrate the present invention and, together with the description, further explain the principles of the invention and enable a person skilled in the pertinent art to make and use the invention.

FIG. 1 is a high level block diagram of an exemplary embodiment. A first unique aspect of the invention is the aggregation of unique long and short assets, defined using a Single Risk Based Strategy. A second aspect is a logic interface with the fixed income markets that oversees a rules-based system and method for applying the risk based logic to the Single Risk Based Strategy.

FIG. 2 is a block diagram of some of the different long/short strategies that can be financed. There are pooled risk-based strategies that incorporate long and short strategies into a single risk-based strategy with various calculable margin requirements.

FIG. 3 is a block diagram of the accompanying credit/Letter of Credit support provided to the Unitary Financial Object. Since the fixed income markets are not use to direct funding of complex risk based strategies, an external credit provider can intermediate the credit support and receive daily risk based reports and be compensated for that protection.

FIG. 4 is an example of the assets flows from a traditional prime brokerage account into a custodian account with individual trading positions (long/short) grouped together.

FIG. 5 is a diagram of the risk hardware components of the Unitary Financial Platform using communications architecture and workstations and processing nodes associated therewith, according to an embodiment of the present invention. FIG. 5 shows information flows into the Unitary Financial Platform as well as outflows of information from the Unitary Financial Platform.

FIG. 6 is a diagram of the architecture of an embodiment of the Unitary Financial Platform, as well as client and bank entities.

FIG. 7 is an illustration of a method of one exemplary embodiment. This particular illustration of the rules in the Rules Engine Object is incorporated in a non-transitory, tangible computer-readable medium. The rules, when executed by a processor, cause a processor to perform a method for a Single Risk Based Strategy based on convertible arbitrage and/or a long convertible short stock strategy.

FIG. 8 is an illustration of an exemplary method for financing trading strategies including convertible arbitrage transactions.

FIG. 9 depicts the daily information flow and computer modeling of specific assets that result in daily external transmissions of data to hedge fund clients with requisite changes in financing levels.

FIG. 10 depicts a high-level block diagram of position/money flows according to an exemplary embodiment.

FIG. 11 is a block diagram of a computer system that is useful for implementing the present invention in accordance with an exemplary embodiment.

### DETAILED DESCRIPTION OF THE INVENTION

### 1. Overview of the Invention

The present invention is directed to a system, method, and computer program product for financing a Single Risk Based Strategy (including convertible arbitrage and other long/short strategies). In one embodiment, a stand alone (“unitary”) financial platform comprises different models (“objects”) to value and monitor the assets. It is unitary in the sense that all objects are under the control and direction of a single entity and are all logically working together as part of the single entity. Further, it does not require brokers as part of the system as this is a financing entity only without brokerage execution. Preferably, the embodiment is implemented in software using object oriented computer communications techniques.

The Unitary Financial Platform described herein provides a number of advantages over the prior art. First, this novel strategy packages the longs and shorts into a single purpose transparent vehicle based on a Single Risk Based Strategy. Second, the platform contains rules-based modules which apply variable margins against securities positions. The Unitary Financial Platform performs daily pricing, risk-based computer modeling, custodial monitoring, client interfacing, and risk reporting to external parties. Third, the funding structure requires that clients contribute capital thereby creating equity in the entity. If multiple parties are involved in a single entity, this requirement puts all clients at risk with respect to the other clients in the context of the rules and provides a clearinghouse like aspect to risk sharing within the entity.

This unitary financing platform enables hedge fund clients to significantly reduce their counterparty risk, as all of the assets are held in a custodian account and can not be used or re-hypothecated by the platform. The risk offsets of this strategy result in a lower cost of financing for hedge fund clients, as the equity underlying the entity is the same equity/margin the client has in its prime brokerage account, but that doesn't get external value in the fixed income markets. Additionally, the costs will be lower due to more transparency in individual pricing in transaction cost aspects.

Because funding is directly from the markets, the unitary financing platform effectively offers term financing with respect to assets that historically have been financed overnight. Clients have a direct look through to the term structure of the entity, which is their implicit term structure.

Further features of the present invention, as well as the structure and operation of various embodiments of the present invention are described in detail below with reference to the accompanying drawings.

### 2. Exemplary Structural Environment

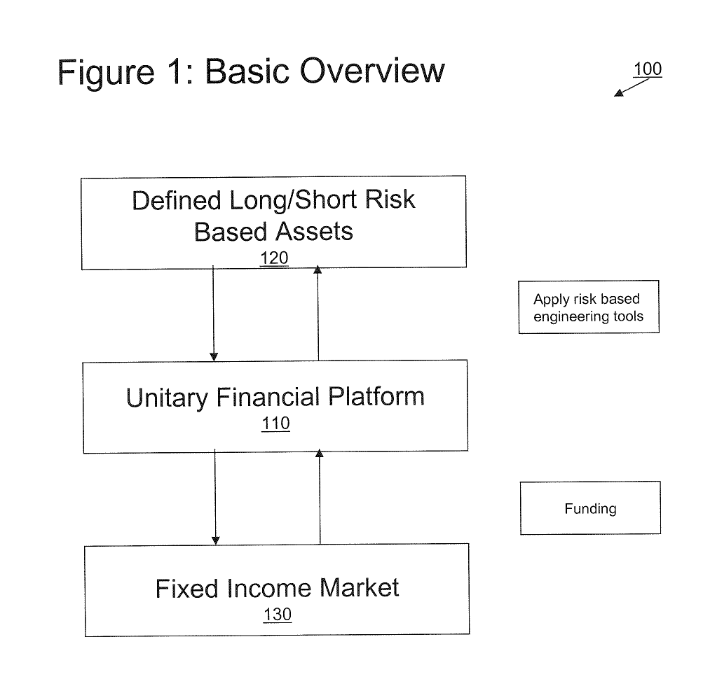

FIG. 1 is a high-level block diagram 100 of the basic structure of the Unitary Financial Platform 110. First note that it aggregates assets, both long and short, along a Single Risk Based Strategy, thus the market price changes in asset valuation will be somewhat offset with corresponding shorts. In general, a portfolio of long and short assets 120 will have lower price movements than a simple long-only portfolio. The Unitary Financial Platform 110 applies risk-based engineering tools to the financial positions in order to better match the long and the short positions based on different principals. All the positions are maintained within the Platform and provide second collateral to the fixed income markets. Second, the Unitary Financial Platform 110 is made up of administrative objects, financial client management objects, and collateral manager objects, the functions of which are described in more detail below. These objects and their methods can be executed by a processor, such as, for example, a processor in a special-purpose computer. The individual components are electronically linked to the electronic finance platform via an electronic communication network 510, such as, for example, the Internet 510. The communications network 510, however, can be any wireless or wireline networks, mobile networks, cable or satellite distribution back channels, online information networks, Internet, Intranet or any other transmission devices. The software used in the platform applications can be web browser, application and communications software. It is preferable that the components and data of the Unitary Financial Platform 110 are logically related to one another. Thus, it is preferred that object-oriented programming techniques define data relationships across the Unitary Financial Platform 110. Although the Unitary Financial Platform 110 is unitary in a logical sense, the communications architecture 510 can be centralized with one or more host server computers or distributed encompassing one or more networks connecting a plurality of computers dedicated to performing the tasks set forth herein. The degree of centralization or distribution is implementation and/or application dependent.

Main memory of the host computers can be random access memory (RAM), read only memory (ROM), EPROM, and/or EEPROM. In addition, an embodiment of the Unitary Financial Platform 110 further includes secondary memory. Secondary memory includes, for example, hard disk drive and/or removable storage drive. Removable storage drive could be, for example, a floppy disk drive, a magnetic tape drive, optical disk, a compact disk drive, a program cartridge and cartridge interface, or a removable memory chip. Removable storage drive reads from and writes to a removable storage unit.

A user, whether a hedge fund 610, custodian, administrator, collateral manager, or letter of credit provider 310, can access the Unitary Financial Platform 110 over a communications network 510, such as, for example, the Internet, using any type of typical user interface known in the art, such as a general purpose computer. In some embodiments, an application programming interface (API) can be downloaded and stored on each client's computer to facilitate faster communications and interoperability with the platform. The API helps facilitate the financial and administrative transactions with the unitary financial platform by providing consistent communications formats and protocols that are compatible with the Unitary Financial Platform 110.

Alternatively, user interfaces can be a personal data assistant, wireless phone, mobile device, cable or satellite set top box or electronic tablet in an embodiment acting alone or in combination with a general purpose computer. As mentioned above, these entities can communicate over wireless or wireline networks, mobile networks, cable or satellite distribution back channels, online information networks, Internet, Intranet or any other transmission medium 510.

In an embodiment, funding for the Unitary Financial Platform 110 comes from the fixed income markets directly, and not from a intermediary's borrowing.

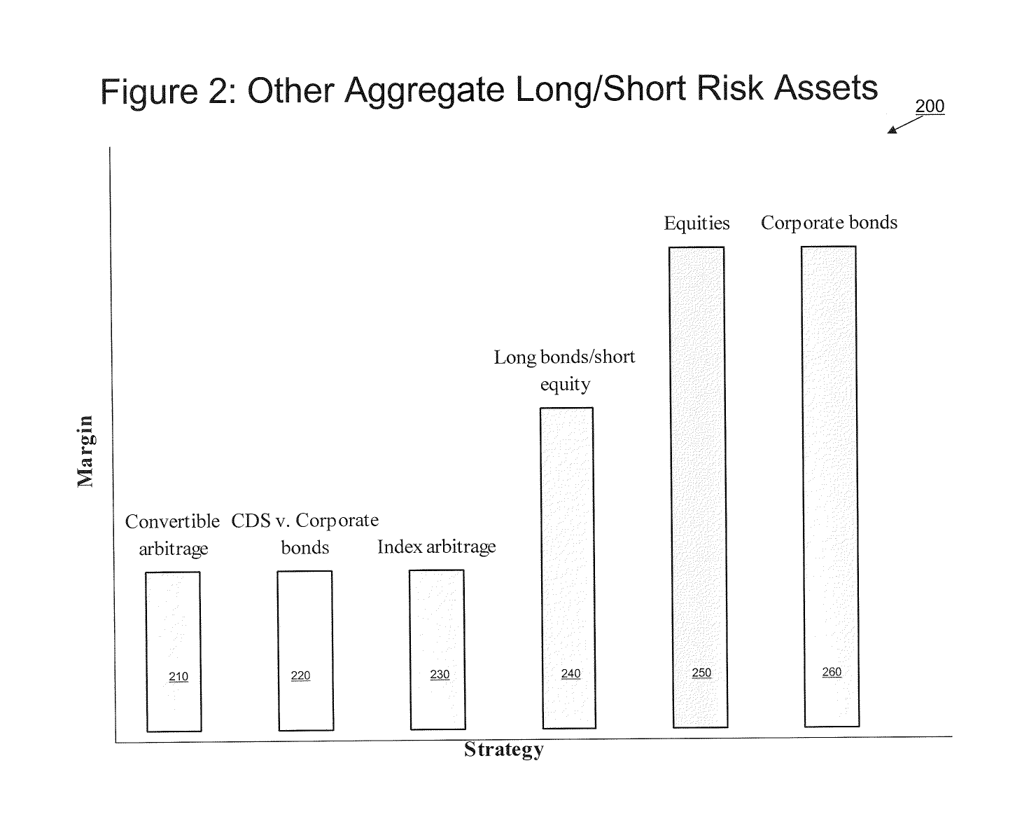

FIG. 2 is a block diagram 200 of exemplary long/short strategies that can be financed using the methods described herein. FIG. 2 shows exemplary long and short strategies for which rules can be applied by the Unitary Financial Platform 110. These are strategies that hedges funds invest in to capture differences in long/short market portfolios. The strategies discussed are exemplary, and not limiting. Convertible arbitrage 210 is discussed. Corporate bonds versus Credit Default Swaps 220 is essentially buying a bond and buying protection on that bond, and capturing the differences in coupons and swaps costs of the transaction. Index arbitrage 230 refers to investing in a basket of securities and taking an offsetting position in a futures contract for the delivery of those assets. Long bond/Short equity of capital structure arbitrage 240 refers to being long one part of a company's equity or liabilities and having an offsetting position in a different liability/equity of the same company. Long short equities 250 is typically executed by taking a long position in stocks that managers like and taking a short position in one they dislike, to profit from both investments. This strategy also applies to long/short positions in corporate bonds 260. Each of these strategies can be discussed as “market neutral,” where the portfolio has significantly less price volatility than a single sided (i.e., long only) strategy.

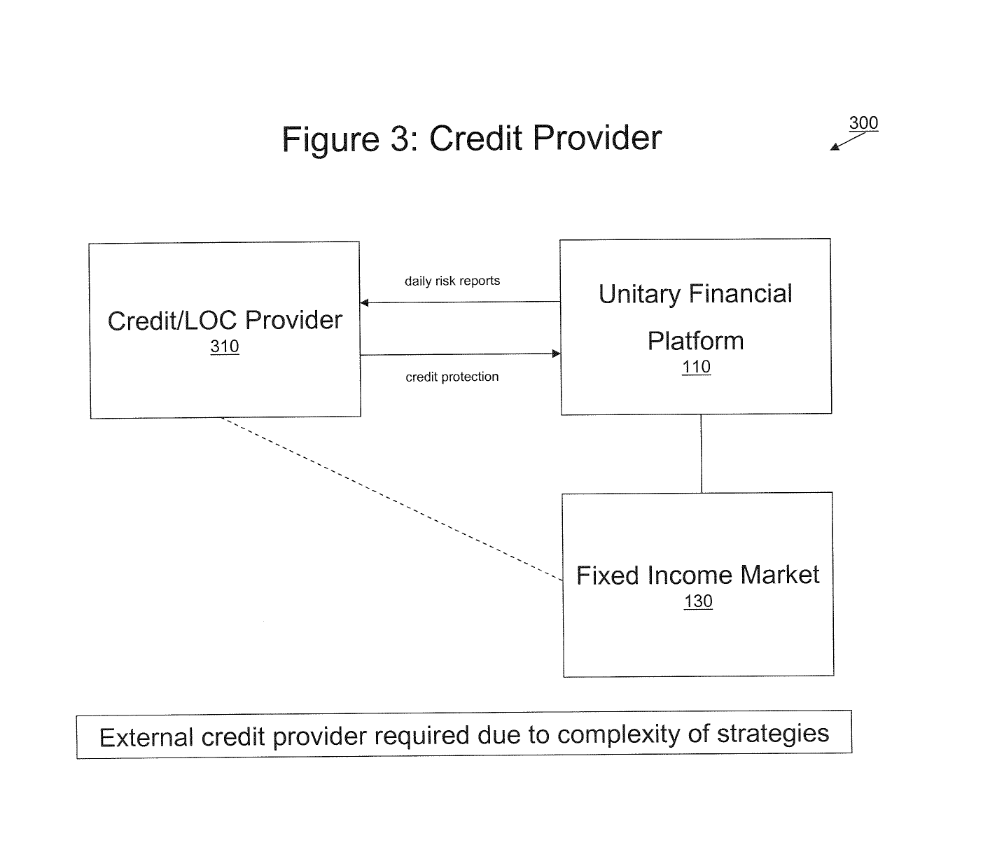

FIG. 3 is a block diagram 300 of the accompanying credit/Letter of Credit (LOC) support provided to the Unitary Financial Platform 110. The credit provider 310 in FIG. 3 is necessary, as the fixed income markets 130 are not accustomed to some of the Risk Based Strategies. External credit enables the fixed income markets to look primarily to the credit provider 310 for repayment of the principal of the securities issued. In exchange for that protection, the Unitary Financial Platform 110 provides daily position reconciliation of both the long and the short assets from the custodian, as well as daily risk reports which can include, for example, VAR (Value At Risk) measures, traditional risk metrics such as delta/gamma/theta per position, per hedge fund client, and across the entire portfolio.

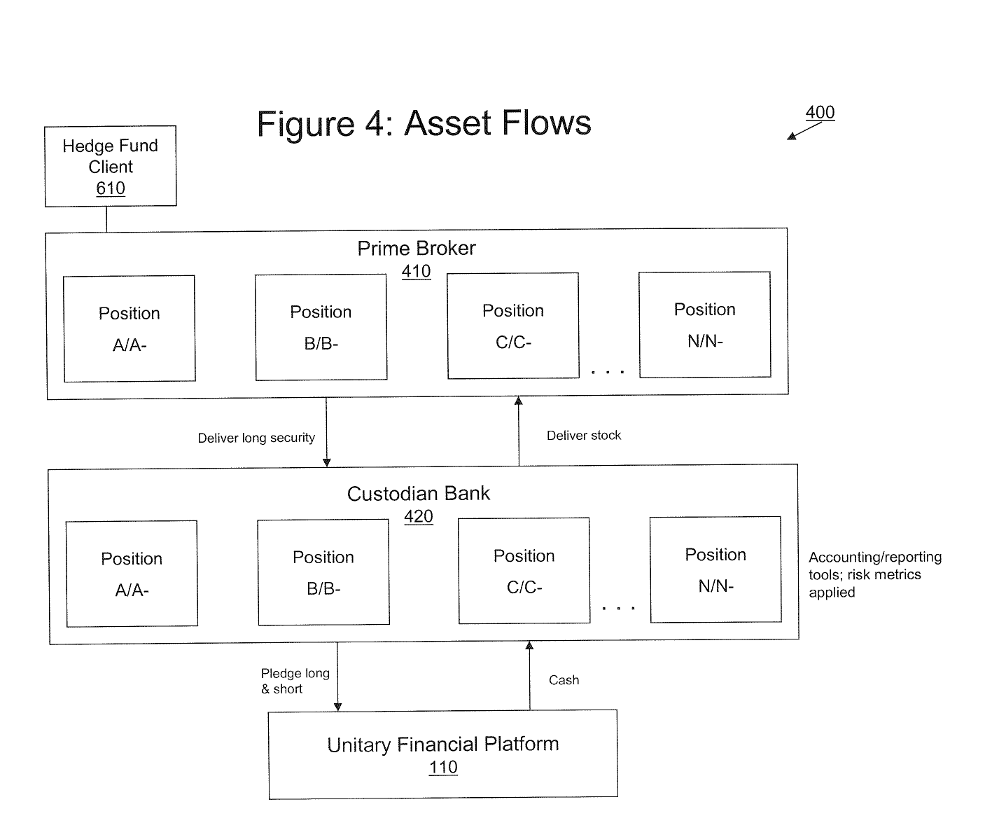

FIG. 4 shows exemplary assets flows 400 from a traditional prime brokerage account into a custodian account with individual trading positions (long/short) grouped together. FIG. 4 shows the initial asset flows from a traditional prime brokerage account 410 into the custodian bank 420. Long positions are moved. Short positions are established by the custodian bank 420 by delivery of stock to the prime broker 410. The delivery of stock effectively establishes a new short position at the custodian bank 420 and closes out or eliminates risk associated with the short position at the prime brokerage account.

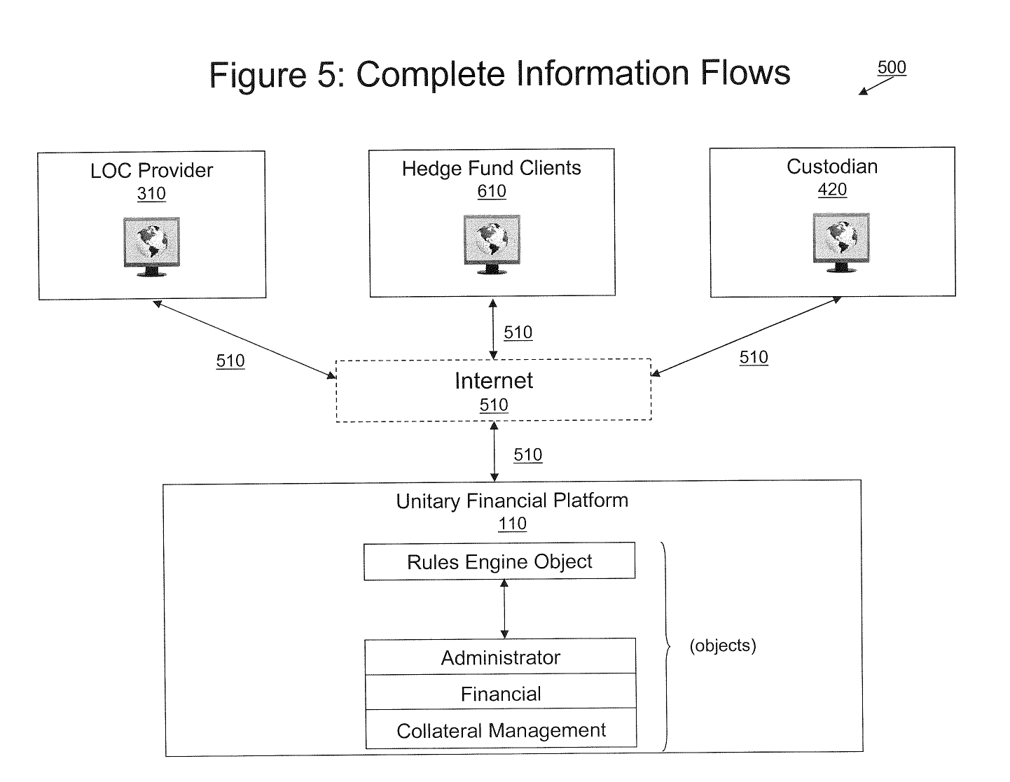

FIG. 5 is a diagram 500 of the risk hardware components of the Unitary Financial Platform 110 using communications architecture 510 and workstations and processing nodes associated therewith, according to an embodiment of the present invention. FIG. 5 shows an exemplary system which incorporate flows both to and from the Unitary Financial Platform 110.

### 3. Operation

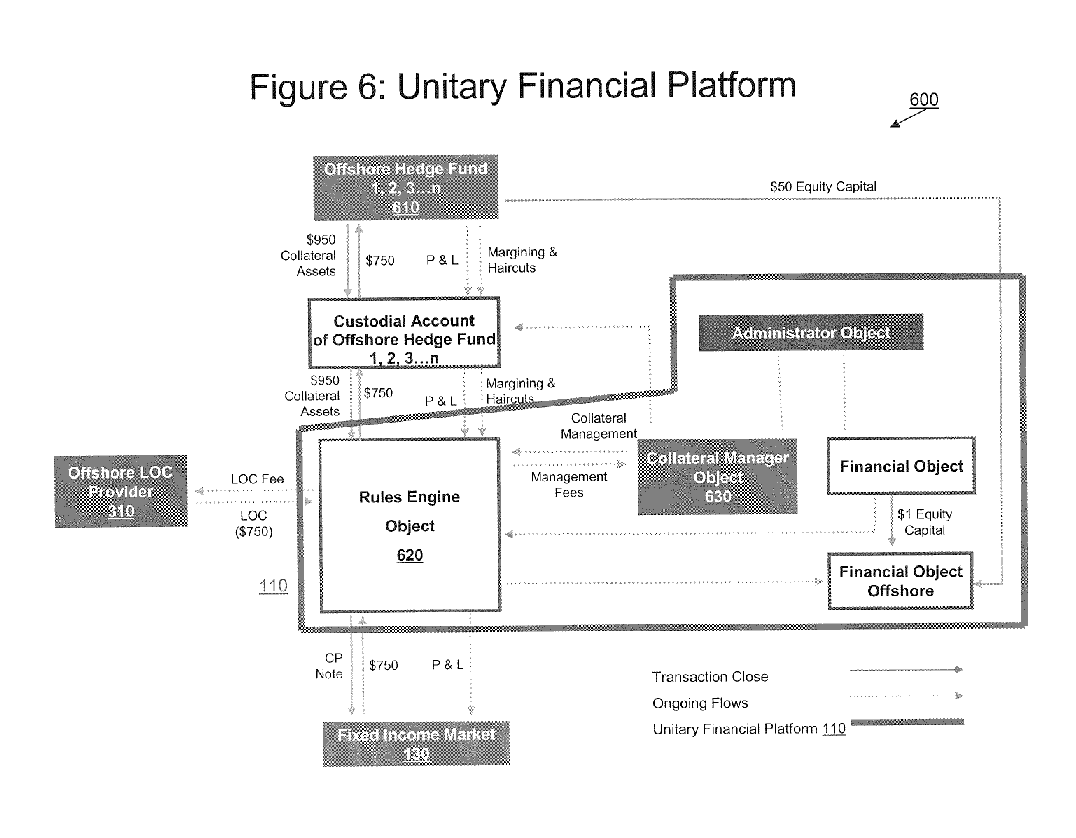

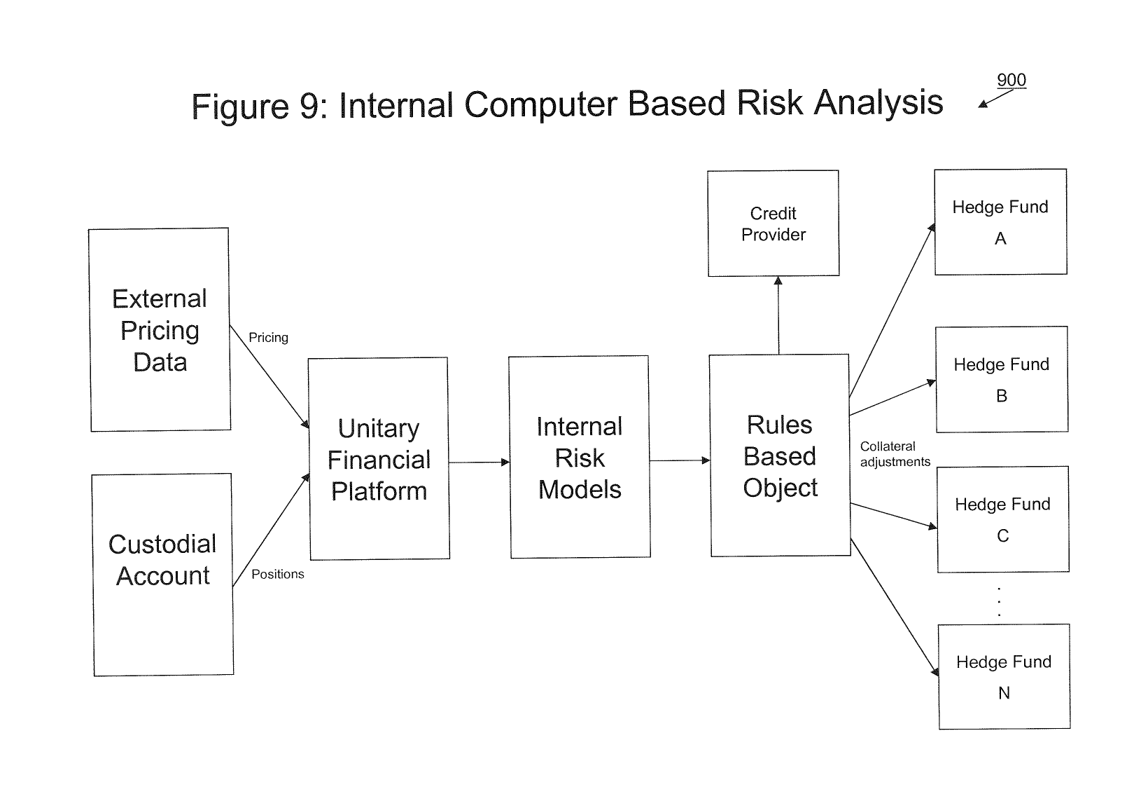

The methods of operation are further described with reference to FIGS. 6 through 10.

FIG. 6 is a diagram 600 of the architecture of an embodiment of the Unitary Financial Platform 110, as well as client and bank entities. FIG. 6 shows the functional relationship of the objects and components in an exemplary embodiment. The hedge fund client 610 transfers its long securities positions into a custodial account at a custodian bank 420. This account is the client hedge fund's account, and is pledged as collateral for loans made by the Unitary Financial Platform 110, shown as the “Custodial Account” in FIG. 6. The custodian bank 420 holds the assets. The custodian bank 420 substantially mitigates counterparty risk to the hedge funds 610. The custodian bank 420 provides direct short locate access and borrow to facilitate the short position. This arrangement is done solely between the custodian bank 420 and the client hedge funds 610. The administrator of the Unitary Financial Platform 110 has a junior lien and/or an assignment of rights on the client short positions at the custodian bank 420.

Referring again to the hedge fund client 610 shown in FIG. 6, the hedge fund client 610 must contribute some percentage of the overall capital of the financial platform. In this example embodiment, roughly 5% of the initial long market value is deposited at a Financial Object as an equity investment in the Unitary Financial Platform 110. The hedge funds' investment in the Unitary Financial Platform 110 serves as equity, providing support to the position. Risk to other parties in the entity has a similar economic impact as that of an owner in a clearing corporation, where each party must meet certain financial constraints daily and if not, the rest of the group is subject to financial risk. The ownership structure reduces adverse incentives in a group situation, as the group is collectively at risk to the other group members.

The Financial Objects administer the Unitary Financial Platform 110 and provide daily monitoring of the portfolios. In addition, the Financial Objects generate collateral excess and requirements notifications by sending messages over the multiple electronic communication networks 510.

Referring again to FIG. 6, “margins and haircuts” are shown as flowing from the client into the bank and then into the Unitary Financial Platform 110. The amounts of such margins and haircuts are determined by a set of rule based modules denoted here as part of the Rules Engine Object 620 in the Unitary Financial Platform 110. The margins are preferably calculated every day by the Rules Engine Object 620. The set of rule based modules of the Rule Engine Object 620 are preferably stored in storage devices such as in read only memory (ROM) or electronic programmable read only memory (EPROM), and backed up in backup storage devices.

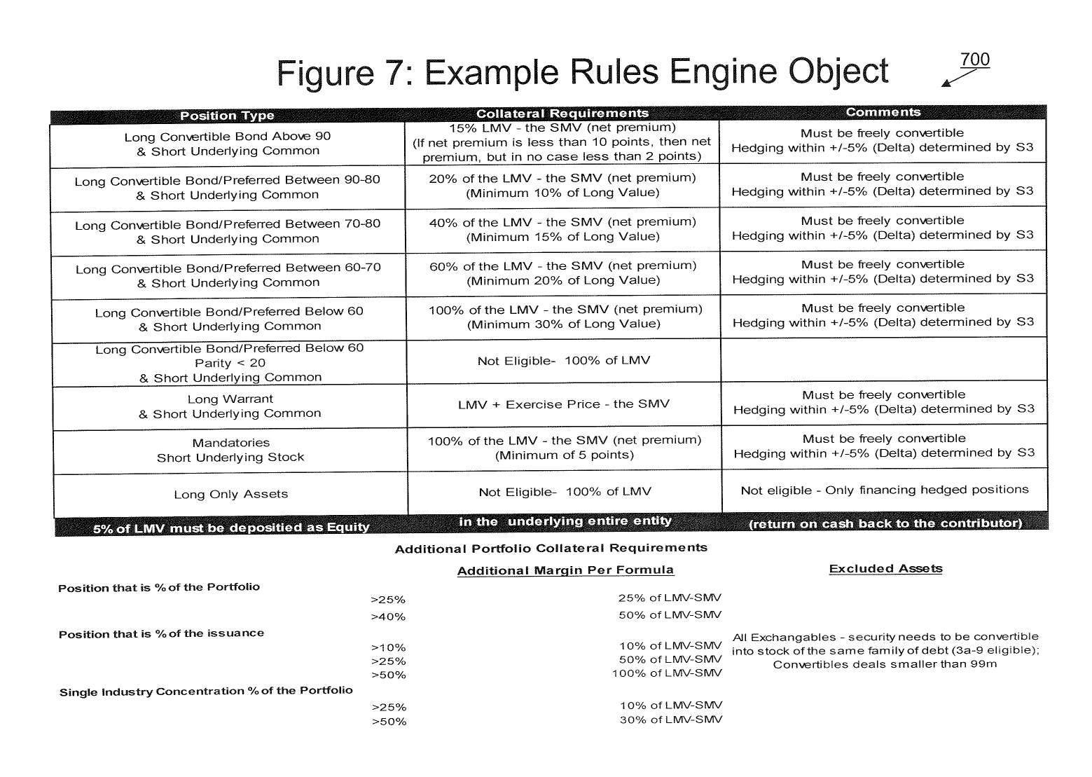

Some of the instruments in Rule Engine Object 620 must be evaluated daily using various financial models for developing the appropriate offsetting position. See FIG. 7. In the convertible arbitrage example, the Collateral Manager 630 is charged with establishing a daily hedge ratio or delta per convertible security in the portfolio. To establish a hedge ratio, the Collateral Manager 630 uses financial assumptions about each security, uses a computer-based convertible model to generate the associated hedge ratios. These models generate reports that require daily interaction, across electronic interfaces, to multiple hedge funds in order to make adjustments as required by the Rules Engine Object 620. Daily settlement adjustments through electronic interfaces are expected for each hedge fund client.

FIG. 7 is an illustration of a method 700 of one exemplary embodiment. This particular illustration of the rules in the Rules Engine Object 620 is incorporated in a non-transitory, tangible computer-readable medium. An exemplary rule-based module stored as part of the Rules Engine Object 620 is shown in FIG. 7. The Unitary Financial Platform 110 modifies, changes, or supplements the rules in the modules based on the risks presented therein (i.e., market liquidity, basis risk, credit risk). In should be noted that each long/short strategy has a different set of rules. The modules are accessed by the Collateral Manager 630 in the platform. Each entity has a different Rules Engine Object 620, as a function of the underlying strategy, the underlying hedge fund client or clients, and/or each Credit Provider 310.

The processes of the Rules Engine Object 620 are now described with reference to the rules in FIG. 7. FIG. 7 shows how the margins and haircuts from the Rules Engine Object 620 are determined. For example, it is assumed that an asset is a $1000 bond. The Rules Engine Object 620 requires computation of a theoretical short or hedge ratio for the bond. This is also known as the “Delta,” i.e., the relationship between the long position and the short position. A particular rule is accessed and/or executed by the processor by identifying the position type and its financial characteristics, such as an assumed credit spread and an assumed stock volatility that have been imputed into a financial model. In non-limiting example, assume that the bond is $1000 with a short of $600. For a long convertible bond above $900, for example, the rule based module of FIG. 7 shows that the collateral requirement will be 15% of the long market value versus the short market value. In the example, this means:

$1000−$600=$400

Thus, applying the 15% rule results in the following:

0.15×$400=$60.

The $60 represents an amount of margin that the hedge fund client must maintain as margin in the account. Funding is now required on $1000-$60 which equals $940. By packaging the short against the convert, the economic risk is $400−$60 which equals $340.

This position can be marked to market everyday. In the example, this results in a fixed income investor economic risk of $340 against $1000 of assets. In this manner, the set of rules shown in FIG. 7 can be applied against the theoretical short. In this embodiment, these types of adjustments are made on a daily basis to ensure that the collateral position is healthy everyday for each individual transaction, as seen in FIG. 4, position A/A− or the long in position A and the corresponding short in A stock. This is required for individual assets of the hedge fund clients. Computer-based modeling across an entire portfolio is the only applicable strategy, given the complexity of the computations and a requirement to do so across a large asset pool.

The systems and methods disclosed herein can be compared favorably against the traditional way, which is for the investment bank 310 to obtain funding in the fixed income market 130 with unsecured debt. In the conventional model, there is no collateral and no mark to market of the portfolio for the benefit of the fixed income security holder. For example, in a typical leverage of 10:1 for the investment bank 310, a fixed income investor has an economic risk of $900 (assuming equity of bank at book).

In the other traditional financing structures of financing in the repurchase market, a $100 loan is secured by a $100 asset, but asset volatility is much higher, as it is based on the single-sided risk of only the long asset. For example, in the difficult markets of '08, repurchase investors became very concerned about the liquidity/pricing assumptions of single sided transactions. As a result, certain assets, such as convertible securities, were no longer accepted as good collateral in that market.

As is evident, the structure of the present invention brings significantly more equity and less economic risk than the traditional unsecured funding strategy. In other words, in an example, the short position effectively creates some “risk free” asset, such as one valued at $660 ($1000−$340), out of a risky asset of $1000. Such an advantage accrues to hedge fund clients in the form of better rates and access to capital in times of distress.

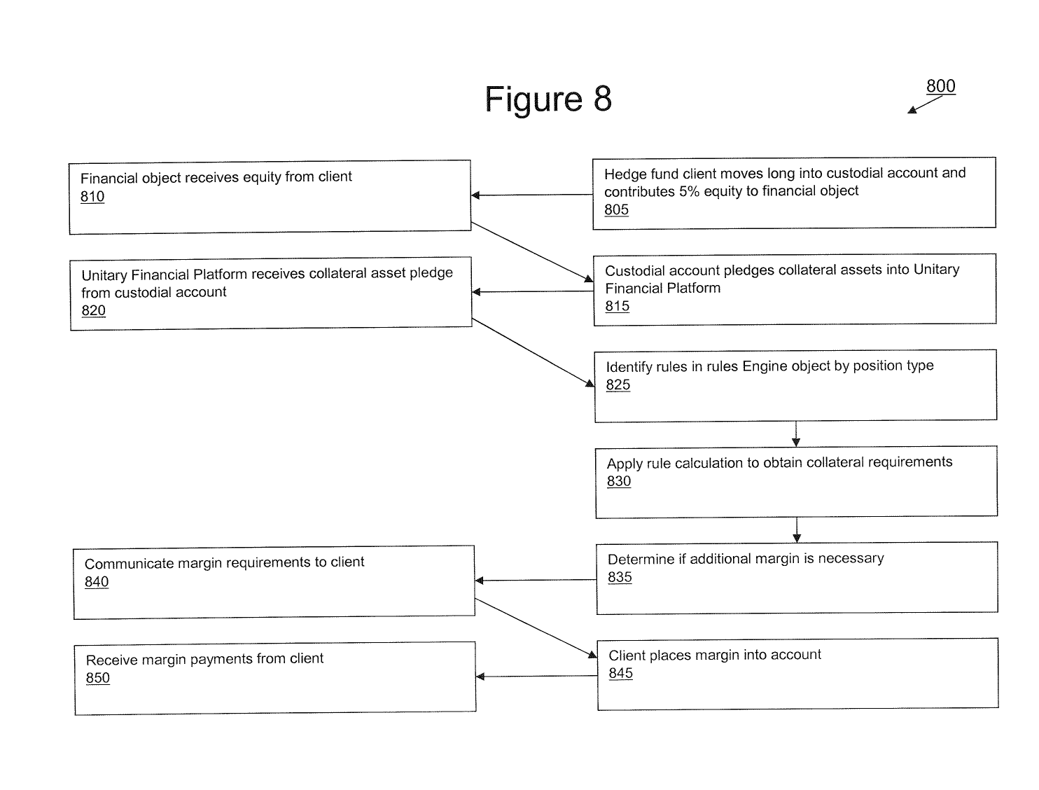

FIG. 8 provides a flow diagram 800 of an exemplary method for financing trading strategies including convertible arbitrage transactions. In the step 805, the hedge fund client transfers roughly 5% of the initial long market value to the Financial Object. In step 810, the financial object receives the equity from the client. In the step 815, the custodial account pledges collateral assets into the Unitary Financial Platform 110. In step 820, the Unitary Financial Platform 110 receives the collateral asset pledge from the custodial account. In step 825, the appropriate rule is identified in the Rules engine object by position type. In the step 830, the calculation associated with the rule is applied to obtain collateral requirements. Next, in step 835, a determination is made as to whether any additional margin is necessary. In step 840, if additional margin is necessary, the margin requirements are communicated to the client. In step 845, the client transfers a margin payment into an account. In step 850, the Unitary Financial Platform 110 receives the margin payment from the client.

Referring again to FIG. 6, the Collateral Manager Object 630 monitors collateral positions on behalf of the Unitary Financial Platform 110 pursuant to rules established in a Collateral Management Agreement and executed by the Rules Engine Object 620. In addition, the computer platform associated with the Collateral Manager Object 630 calculates asset and collateral valuations. The mark-to-market and collateral valuations can be done daily in conjunction with margining requirements.

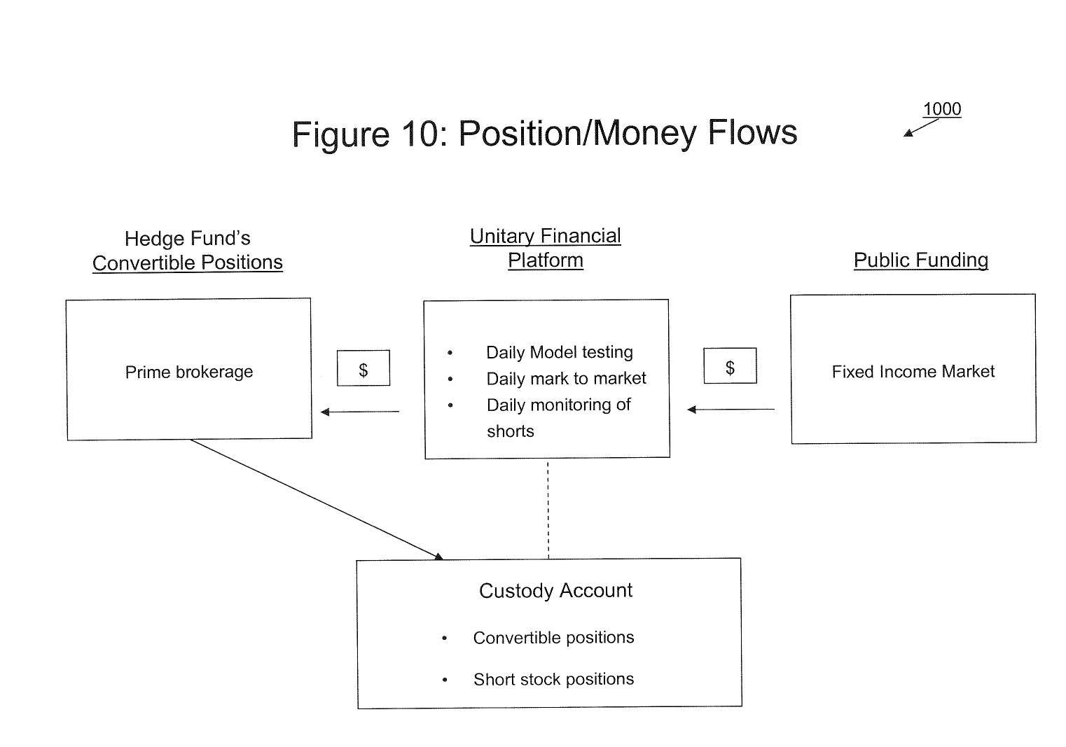

FIG. 10 shows an exemplary high-level overview 1000 of the position and money flows of the Unitary Financial Platform 110.

As is typical with funding vehicles without a credit history, such as the Unitary Financial Platform 110, there is a need to obtain a rating or credit support. Referring again to FIG. 3, a bank, shown as the letter of credit provider 310 (“LOC Provider”), provides credit support. Fixed income investors therefore look to the LOC Provider 310 as a primary obligor. Therefore, the Unitary Financial Platform 110 provides the LOC Provider 310 with daily electronic risk and other reports including access information, Internet communications status and other communications messages.

The invention provides an elegant and transparent way to finance assets as a stand alone (i.e., unitary) strategy. A rule for executing a risk-based strategy (for example, a long convertible/short stock strategy) is stored in the Unitary Financial Platform 110 shown in FIGS. 4 through 10. This differs substantially from the prior art. In the prior art, an investment bank 310 provides financing for convertibles. As mentioned above, this financing is not transparent due to the complexities of the commingling of assets. To the contrary, the Unitary Financial Platform 110 is implemented to segregate each strategy, instead of the prior practice of commingling strategies. Here, the Unitary Financial Platform 110 finances convertibles against short stock positions. The Unitary Financial Platform 110 can mark long and short positions daily. Another advantage is the novel packaging of long and short positions in a manner that reduces risk.

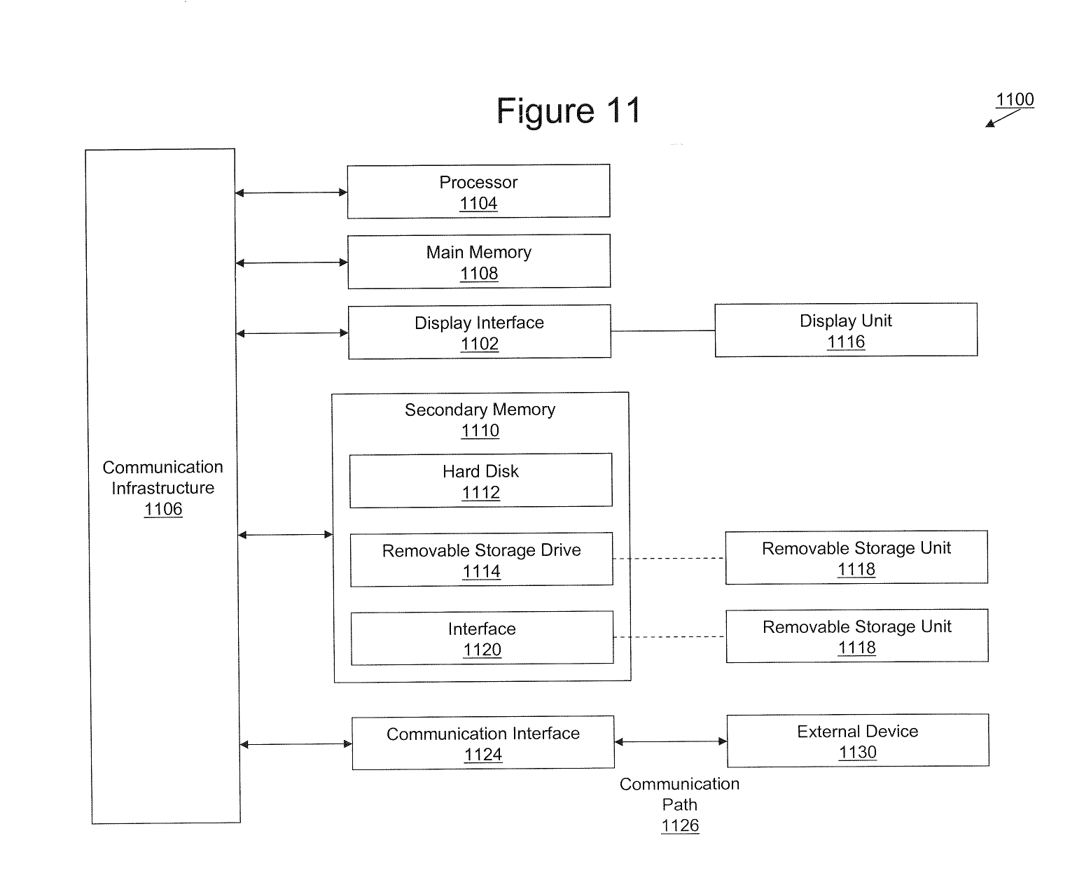

FIG. 11 is a block diagram of a computer system 1100 used to implement the invention in accordance with an exemplary embodiment. The invention is described herein in terms of functional block components and various processing steps. It should be appreciated that such functional blocks can be realized by any number of hardware or software components configured to perform the specified functions. For example, the invention can employ various integrated circuit components, e.g., memory elements, processing elements, logic elements, look-up tables, and the like, which can carry out a variety of functions under the control of one or more microprocessors or other control devices. The examples described herein are illustrative of the invention and are not intended to otherwise limit the scope of the invention in any way.

Each participant or user of the system of the invention can be equipped with a suitable computing system to facilitate communications and transactions with any other participant. Some or all participants can have access to a computing unit in the form of a computer. Additionally, other participants can have computing systems in the form of a computer server, networked computers, or any other suitable implementations. The computing systems are connected with each other via a data communications network. The data communication network can be a public network, such as the Internet.

As will be appreciated, the invention can be embodied as a method, a data processing system, a device for data processing, or a computer program product. Furthermore, the invention can take the form of a computer program product on a computer-readable storage medium having computer-readable program code means embodied in the storage medium. Any suitable computer-readable storage medium can be utilized, including a hard disk, a CD-ROM, an optical storage device, a magnetic storage device, or the like.

Systems and methods are described herein with reference to at least one block diagram and at least one flowchart of a method, an apparatus (e.g., system), and a computer program product according to various aspects of the invention. Each functional block and combinations of functional blocks in the block diagram and flowchart illustration, respectively, can be implemented by computer program instructions. These computer program instructions can be loaded onto a computer or other programmable data processing apparatus to produce a machine that implements a function described herein.

Computer program instructions can be stored in a computer-readable memory that can direct a computer or other programmable data processing apparatus to function in a particular manner, such that the instructions stored in the computer-readable memory produce an article of manufacture including instruction means which implement the function described herein. The computer program instructions can also be loaded onto a computer or other programmable data processing apparatus to cause a series of operational steps to be performed on the computer or other programmable apparatus to produce a computer-implemented process, such that the instructions which execute on the computer or other programmable apparatus provide steps for implementing the function described herein.

The methods and processes herein (i.e., the system and process listed above or any part(s) or function(s) thereof) can be implemented using hardware, software, or a combination thereof. The methods and processes herein can be implemented in one or more computer systems or other processing systems. The manipulations performed are often referred to in terms which are commonly associated with mental operations performed by a human operator. No such capability of a human operator is necessary, or desirable in most cases, in any of the operations described herein. Rather, the operations are machine operations. Useful machines for performing the operation of the invention include general purpose digital computers or similar devices. In an example, computer system 1100 performs at least a part of a method described herein.

Computer system 1100 includes a processor 1104. Processor 1104 is connected to a communication infrastructure 1106. Computer system 1100 can include a display interface 1102 that forwards graphics, text, and other data from communication infrastructure 1106 (or from a frame buffer not shown) for display on display unit 1116.

Computer system 1100 also includes a main memory 1108, preferably random access memory (RAM), and can also include a secondary memory 1110. Secondary memory 1110 can include, for example, a hard disk drive 1112 or a removable storage drive 1114, representing a floppy disk drive, a magnetic tape drive, an optical disk drive, an information storage device, etc. Removable storage drive 1114 reads from and writes to a removable storage unit 1118. Removable storage unit 1118 represents a magnetic disk, an optical disk, etc. which is read by, and written to, by removable storage drive 1114. Removable storage unit 1118 includes a computer usable storage medium having information such as a computer program or data stored therein.

In alternative embodiments, secondary memory 1110 can include other similar devices for allowing computer programs or other instructions to be loaded into computer system 1100. Such devices can include, for example, removable storage unit 1118 and an interface 1120. Examples of secondary memory 1110 include a program cartridge and cartridge interface, a removable memory chip (such as an erasable programmable read only memory (EPROM), and programmable read only memory (PROM)) with an associated socket, and removable storage unit 1118 or interface 1120, which allow software and data to be transferred from removable storage unit 1118 to computer system 1100.

Computer system 1100 can also include a communications interface 1124. Communications interface 1124 allows software and data to be transferred between computer system 1100 and an external device 1130. Examples of communications interface 1124 can include a modem, a network interface (such as an Ethernet card), a communications port, a Personal Computer Memory Card International Association (PCMCIA) slot and card, etc. Software and data transferred via communications interface 1124 are in a form capable of being received by communications interface 1124 via a communications path 1126. Communications path 1126 can be implemented using a wire, fiber optics, a telephone line, a cellular link, a radio frequency (RF) link, or the like.

In this document, the terms “computer program medium” and “computer usable medium” are used to generally refer to media such as removable storage drive 1114 or a hard disk installed in hard disk drive 1112. Computer program products such as a computer program medium and a computer usable medium provide instructions to computer system 1100. The invention is directed in part to such computer program products.

Computer programs (also referred to as computer control logic) are stored in main memory 1108 or secondary memory 1110. Computer programs can also be received via communications interface 1124. Such computer programs, when executed, enable computer system 1100 to perform at least one feature of the invention, as discussed herein. In particular, the computer programs, when executed, enable processor 1104 to perform at least one feature of the invention. Accordingly, such computer programs represent controllers of computer system 1100.

If the invention is implemented using software, the software can be stored in a computer program product and loaded into computer system 1100 using removable storage drive 1114, hard drive 1112, or communications interface 1124. The control logic (software), when executed by processor 1104, causes processor 1104 to perform the functions of the invention as described herein. In another embodiment, the invention is implemented as a hardware state machine using hardware components such as an application specific integrated circuit (ASIC).

While various embodiments of the invention have been described above, it should be understood that they have been presented by way of example only and not limitation. The various embodiments of the invention can include many different types of long/short strategies so long as they are segregated in the vehicle. For example, other types of securities which can be covered with other types of hedging techniques are also included and covered by the invention including long/short equity, long/short bonds (e.g., corporates, mortgages, governments, and municipals), bonds versus CDS, equities or bonds versus indices/futures as depicted in FIG. 2. It will be understood by those skilled in the art that various changes in form and details can be made therein without departing from the spirit and scope of the invention as defined in the appended claims. Thus, the breadth and scope of the invention is not limited by any of the above-described exemplary embodiments.

What is claimed is:

1. A computer-based method for risk-based financing for long/short strategies applying rules-based logic to a single risk based strategy, comprising:
packaging long positions and short securities positions into a single purpose transparent financial vehicle, based on a single risk based strategy using risk-based engineering tools; and
pledging those securities positions as collateral for an extension of credit using a rules-based object.

2. A computer-based method of claim 1, comprising:
applying variation margin against long and short securities positions using rules-based modules;
determining respective values of long and short positions of a client by marking the long and short positions to market using a unitary financial platform;
identifying a rule based on the types of long and short positions and their relationship using a rules engine object;
calculating a collateral requirement based on the rule on a daily basis using the rules engine object; and
determining an additional margin value based on the rule using the rules engine object.

3. The computer-based method of claim 2, wherein if the additional margin value is positive, communicating the additional margin value to the client using the rules engine object.

4. The computer-based method of claim 3, further comprising receiving a transfer of margin funds from the client using the rules engine object.

5. The computer-based method of claim 4, further comprising allowing the client to access the margin funds in excess of the rules based margin value using the rules engine object.

6. A computer-based method for reducing credit exposure to an entity, comprising:
receiving, by the entity, a margin payment from a client using a financial object, wherein a portion of the margin payment represents a variable margin payment; and
the remainder of the margin payment represents a fixed payment which is treated as capital in exchange for an equity interest in the entity to the client.
